(19) United States
(12) Patent Application Publication
(10) Pub. No.: US 2023/0206926 A1
(43) Pub. Date: Jun. 29, 2023

(54) A DEEP NEURAL NETWORK TRAINING METHOD AND APPARATUS FOR SPEAKER VERIFICATION

(71) Applicant: Northwestern Polytechnical University, Xi'an, Shanxi (CN)

(72) Inventors: Zhongxin BAI, Xi'an, Shanxi (CN); Xiao-Lei ZHANG, Xi'an, Shanxi (CN); Jingdong CHEN, Xi'an, Shanxi (CN)

(73) Assignee: Northwestern Polytechnical University, Xi'an, Shanxi (CN)

(21) Appl. No.: 17/926,605

(22) PCT Filed: Sep. 21, 2020
(86) PCT No.: PCT/CN2020/116410

§ 371 Date: Nov. 20, 2022

(51) Int. Cl. G10L 17/04; G10L 17/18; G10L 17/02; G10L 17/08

(52) U.S. Cl. CPC G10L 17/04; G10L 17/18; G10L 17/02; G10L 17/08

(57) ABSTRACT

A feature extraction deep neural network (DNN) may be trained based on the minimization of a loss function. A similarity function may be specified to calculate a similarity score for two representations of verbal utterances. A training data set comprising pairs of representations of utterances is received, wherein each one of the pairs of representations of utterances is associated with a corresponding a ground-truth label confirming whether the pair of represented utterances come from a same speaker or not. A respective similarity score may then be calculated for each one of the pairs of representations of utterances. Parameters associated with the DNN may then be updated based on minimizing a loss function associated with an area under a section of a receiver-operating-characteristic (ROC) curve for the similarity scores, wherein the ROC curve section is delimited between a low false positive rate (FPR) value and a high FPR value.

### TECHNICAL FIELD

This disclosure relates to speaker verification and, in particular, to training of deep embedding neural networks for text-independent speaker verification.

### BACKGROUND

Speaker verification aims to verify the claimed identity of a speaker pronouncing an utterance based on comparing the utterance to pre-recorded utterances known to be from the claimed identity. Speaker verification may be text-dependent or text-independent. Text-dependent speaker verification requires the speaker to pronounce a predefined text, while text-independent speaker verification does not have such a requirement. Text-independent speaker verification may be generally categorized into two classes of methods. One class of speaker verification system include a deep neural network (DNN) that can project the utterances to a lower-dimension feature space.

The deep neural network (DNN) may be used in speech processing. Neural networks are machine learning models that employ one or more layers of nonlinear units to predict an output for a received input. Some neural networks (e.g., DNN) include one or more hidden layers in addition to an output layer. The output of each hidden layer is used as input to the next layer in the neural network, i.e., the next hidden layer or the output layer. Each layer of the neural network generates an output from a received input in accordance with current values of a respective set of parameters.

### BRIEF DESCRIPTION OF THE DRAWINGS

The present disclosure is illustrated by way of example, and not by way of limitation, in the figures of the accompanying drawings.

FIG. 1 shows a flow diagram illustrating a method for using a loss function to train a deep neural network (DNN), according to an embodiment of the present disclosure.

FIG. 2 shows a flow diagram illustrating a method for determining that an utterance comes from a known speaker based on a generated similarity score matching or exceeding a specified threshold value, according to an embodiment of the present disclosure.

FIG. 3 shows a flow diagram illustrating a method for computing a false positive rate (FPR) for a receiver-operating-characteristic (ROC) curve based on similarity scores and ground-truth labels, according to an embodiment of the present disclosure.

FIG. 4 shows a flow diagram illustrating a method for forming a training data set based on a respective class center assigned to each of a plurality of training speakers, according to an embodiment of the present disclosure.

FIG. 5 shows a graph of an ROC curve, wherein a section of the ROC curve is delimited between a low FPR value and a high FPR value, according to the present disclosure.

FIG. 6 shows a detection error tradeoff (DET) graph for multiple loss functions plotting their respective false negative rates vs. their respective false positive rates for a specified task, according to an embodiment of the disclosure.

FIG. 7 shows a block diagram illustrating an exemplary computer system, according to an embodiment of the present disclosure.

### DETAILED DESCRIPTION

Many speaker recognition methods may be separated into three stages with the first stage being the training stage. In this stage, a front-end feature extractor (DNN) mode is trained along with some back-end modes (such as LDA+PLDA, Mahalanobis metric etc.). The present disclosure describes the use of a cost function for the training of the front-end feature extractor DNN.

The second stage is the enrollment stage. In this stage an identity vector (e.g., voice print, template or representation) for each enrollment utterance (e.g., each “known” utterance) may be extracted by the trained DNN of the first stage. If there are more than one enrollment utterances for one speaker, all representations of the enrollment utterances may be averaged to construct a unique identity vector for that speaker. In the present disclosure a speaker for which the method has extracted an identity vector is a “known” speaker.

The third stage is the test stage. In this stage, representations for test utterances must be extracted. Furthermore, in order to verify whether the test utterance comes from the enrollment speaker, a similarity score of the test and enrollment representations may be computed by the trained back-end models. Finally, the similarity score may be compared with a predefined threshold value to make decisions for verification.

A text-independent speaker verification system may use DNNs to project speech recordings with different lengths into a common low dimensional embedding space where the speakers' identities are represented. Such a method is called deep embedding, where the embedding networks (e.g., DNNs) may include three components: a network structure including the hidden layers, a pooling layer, and a loss function for training the network.

Generally, there are two types of loss functions, i.e., identification and verification loss functions. The difference between the verification loss function and identification loss function is that the verification loss function needs to construct pairwise or triplet training trials, which imitates the enrollment and test stages of speaker verification. This imitation matches the process of speaker verification ideally while its implementation faces some difficulties in practice. One of those is that the number of all possible training trials increase cubically or quadratically with the number of training utterances, thus dramatically increasing the requirement for computation resources (e.g., processor cycles and memory usage). As a result, many of the commonly used deep speaker embedding methods choose to optimize the identification loss function instead. The identification loss function, however, does not imitate the enrollment and test stages of speaker verification, thereby resulting in less optimal verification results.

An equal error rate (EER) for the false acceptance rate and false rejection rate may be used to measure the performance of speaker verification. Furthermore, although directly optimizing an evaluation metric of speaker verification may improve the performance, current methods focus mainly on optimizing EER, while most speaker verification systems usually work at different points of their receiver-operating-characteristic (ROC) curve (a graph of the diagnostic ability of a binary classifier system as its discrimination threshold is varied) for different applications (e.g., bank system vs. security system). The points of interest for an application may not coincide with the EER point on the ROC curve.

The present disclosure describes the use of a loss function (also referred to as a cost function) for the training of the front-end feature extractor DNN for the speaker verification methods with front-end feature extractors and back-end classifiers. As noted above, the speaker verification system that reaches the minimum EER may not be the best at other points of interest along the system's ROC curve. To optimize the system's performance at other points of interest for deep embedding based text-independent speaker verification, the parameters of the front-end feature extractor DNN may be optimized through a training process to maximize the area under the part of the system's ROC curve where said other points of interest are located (denoted as partial AUC or pAUC for short). The pAUC may also be used as a supplemental evaluation metric used to fine tune other speaker verification metrics.

A verification system algorithm may use predetermine threshold values for its false acceptance rate and false rejection rate. When both rates are equal, the common value is referred to as the equal error rate. The lower the equal error rate value, the higher the accuracy of the verification system. Accordingly, the EER is a common evaluation metric for speaker verification. However, it may not always satisfy the requirements of real-world applications. For example, a bank security system may be interested in the FPR at an extremely low range (e.g., lower than 0.01%), whereas a terrorist detection system of a public security department may be interested in the FPR at a large recall rate range, such as higher 99%. In either case, the point on the system's ROC curve where the optimal EER point is located is not the primary concern of the speaker verification systems. Therefore, it may be better to optimize over a section of the ROC curve directly instead of optimizing a single EER point on the ROC curve. One way of optimizing the ROC curve is to maximize an area under the ROC curve (AUC). Therefore, since optimizing the whole ROC curve is costly and, in most cases, needless, the present disclosure will focus on maximizing the partial AUC (pAUC) for the ROC curve where points of interest for a particular speaker verification system are located.

Furthermore, during the training stage, the DNN model including the pAUC loss function may be improved by making use of a class-center based learning approach. Accordingly, the present disclosure describes a class center-based approach wherein centers are assigned to speaker identity classes of the training speakers and the assigned class centers are updated at each iteration of the training. The class-centers may be used as enrollments to construct training trials at each optimization epoch (e.g., iteration) of the pAUC loss function of the deep embedding speaker verification system.

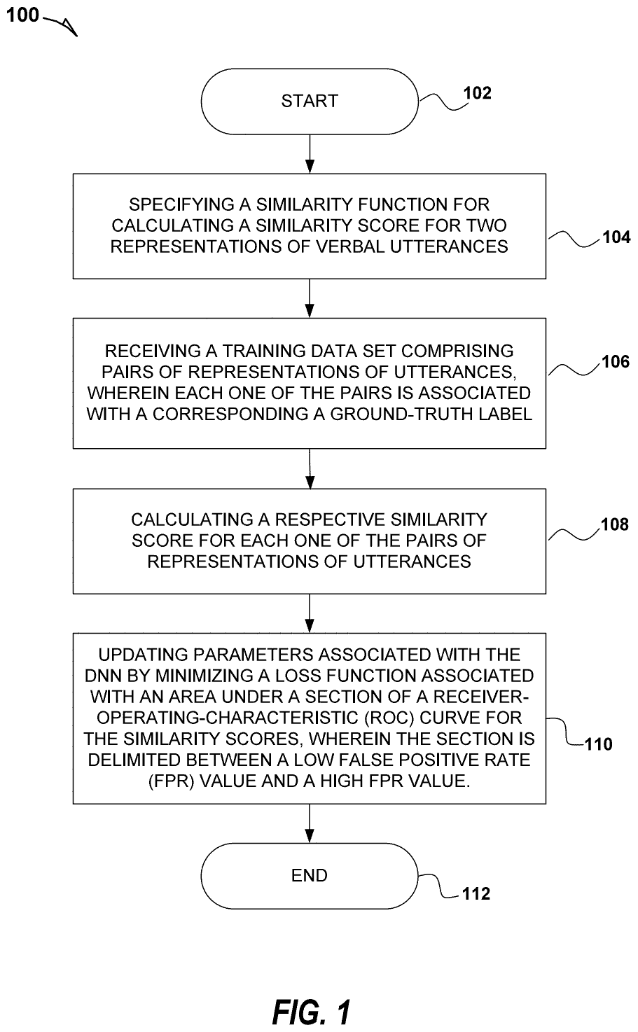

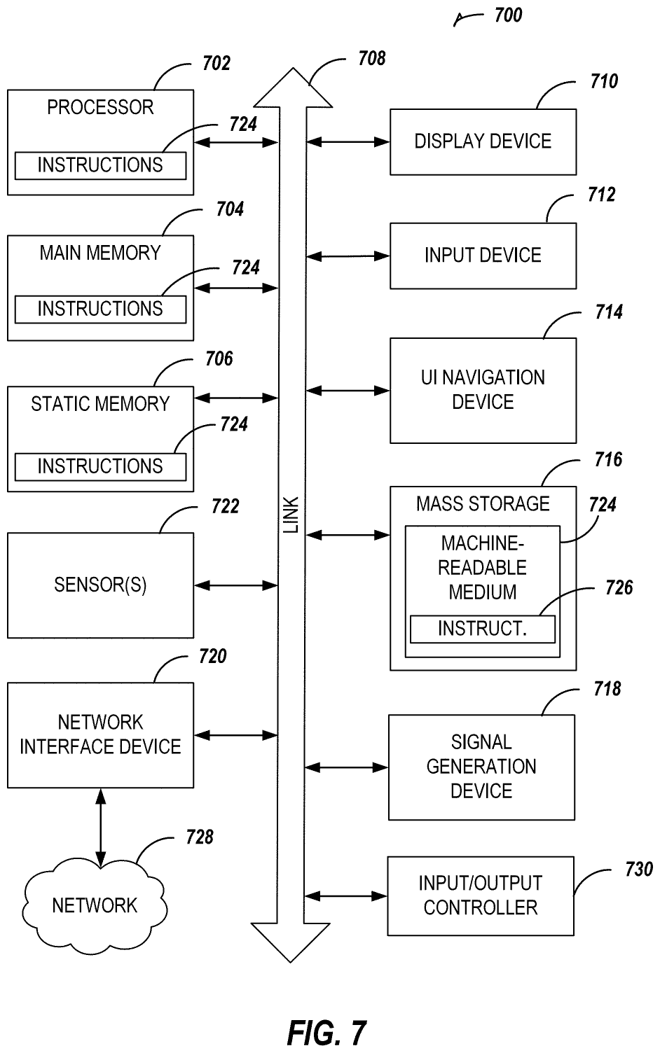

FIG. 1 shows a flow diagram illustrating a method 100 for using a loss function to train a deep neural network (DNN), according to an embodiment of the present disclosure. The method 100 may be performed by processing logic that comprises hardware (e.g., circuitry, dedicated logic, programmable logic, microcode, etc.), software (e.g., instructions run on a processing device to perform hardware simulation), or a combination thereof, such as computer system 700 as described below with respect to FIG. 7.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring to FIG. 1, at 102, the processing device may start executing any preliminary operations required for training the feature extractor DNN.

For example, an initial training data set for training the feature extractor DNN may be generated based on a set of utterance representations χ={xᵤᵥ|u=1, . . . , U; v=1, . . . , Vᵤ}, where u and v represent the v^{th} utterance of the u^{th} speaker (based on feature-extraction from captured audio signals), U is the total number of the speakers and Vᵤ is the utterance number of the u^{th} speaker. A training data set [symbol] may be constructed at each mini-batch iteration (including the initial training set for the first iteration) of the training of a DNN by a random sampling strategy as follows: randomly select t speakers from χ, then randomly select two utterances from each of the selected speakers, and finally construct [symbol] by a full permutation of the 2t utterances.

At 104, the processing device may specify a similarity function (e.g., a cosine similarity function) for calculating a similarity score for two representations of utterances.

As noted in the example of 102 above, a training data set may be constructed at each iteration during the training stage. In an embodiment of the present disclosure, we may construct a pairwise training set [symbol] ={(xₙ, yₙ; lₙ)|n=1, 2, . . . , N} where xₙ and yₙ are the representations of two utterances at the output layer of the DNN model, and lₙ is the ground-truth label indicating the similarity of xₙ and yₙ (i.e., if xₙ and yₙ come from the same speaker, lₙ=1; otherwise, lₙ=0). For a specified soft similarity function ƒ(·) (e.g., a cosine similarity function), a similarity score may be determined for xₙ and yₙ, denoted as sₙ=ƒ(xₙ, yₙ) where sₙ∈ [symbol] . The decision for the similarity of xₙ and yₙ is:

$${\hat{l}}_{n} = \{ \begin{matrix}1 , & if {s}_{n} \geq θ \\ 0 , & otherwise\end{matrix} , n = 1 , … , N ,$$

where θ is a specified decision threshold value wherein \hat{l}ₙ=1 for a pair of representations indicates that they come from the same speaker and \hat{l}ₙ=0 for a pair of representations indicates that they come from the different speakers.

At 106, the processing device may receive a training data set comprising pairs of representations of utterances, wherein each one of the pairs of representations of utterances is associated with a corresponding a predetermined ground-truth label.

As noted above with respect to 104, the training data set may comprise a pairwise training set [symbol] ={(xₙ, yₙ; lₙ)|n=1, 2, . . . , N} where xₙ and yₙ are the representations of two utterances at the output layer of the DNN model, and lₙ is the ground-truth label indicating the similarity of xₙ and yₙ (i.e., if xₙ and yₙ come from the same speaker, lₙ=1; otherwise, lₙ=0).

At 108, the processing device may calculate a respective similarity score for each pair of representations of utterances.

As noted above with respect to 102, a given a soft similarity function ƒ(·) may be used to calculate a similarity score for representations xₙ and yₙ, denoted as sₙ=ƒ(xₙ, yₙ) where sₙ ∈ [symbol] . The decision for the similarity (e.g., 1=similar, 0=not similar) of representations xₙ and yₙ is:

$${\hat{l}}_{n} = \{ \begin{matrix}1 , & if {s}_{n} \geq θ \\ 0 , & otherwise\end{matrix} , n = 1 , … , N ,$$

where θ is a specified decision threshold value. For example, as noted above, in one embodiment of the present disclosure the similarity function ƒ(·) specified for calculating the similarity scores may be the cosine similarity function:

$${s}_{n} = f ( {x}_{n} , {y}_{n} ) = \frac{{x}_{n}^{T} {y}_{n}}{‖ {x}_{n} ‖ ‖ {y}_{n} ‖} ,$$

where the superscript T is the transpose operator and ∥·∥ is the [symbol] ₂-norm operator.

At 110, the processing device may update parameters associated with the DNN based on minimizing a loss function associated with an area under a section of a receiver-operating-characteristic (ROC) curve for the similarity scores, wherein the section is delimited between a low false positive rate (FPR) value and a high FPR value.

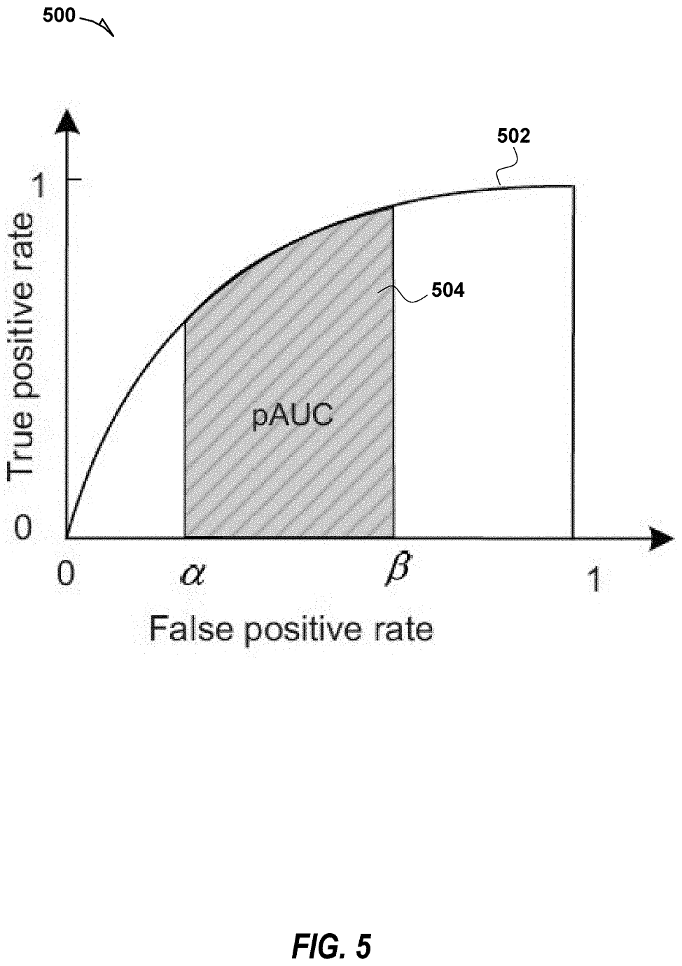

With a given value for θ, a true positive rate (TPR) and a false positive rate (FPR) may be computed from the values of \hat{l}ₙ, for n=1, . . . , N. The TPR may be defined as the ratio of the positive trials (i.e., ground-truth label lₙ=1=same speaker) that are correctly predicted (i.e., \hat{l}ₙ=1) over all trials indicating a positive result. Whereas, the FPR may be defined as the ratio of the negative trials (i.e., ground-truth label lₙ=0=different speakers) that are wrongly predicted (i.e. \hat{l}ₙ=1) over all trials indicating a negative result. Varying θ gives a series of values for {TPR(θ), FPR(θ)}, which form a ROC curve as (e.g., as described more fully below with respect to FIG. 5). The pAUC for the ROC curve may be defined as the area under the ROC curve when the value of the FPR is between [α, β], wherein α and β are two hyper-parameters. As noted above, α and β may be specified based on the requirements of the specific speaker verification application, e.g., different points of interest along the ROC curve for the application. In this way, embodiments of the present disclosure may train the feature extraction DNN with deep embedding for a specific speaker verification application, thus providing a flexible framework for speaker verification applications.

To calculate the pAUC, embodiments of the present disclosure first construct two sets [symbol] ={(sᵢ, lᵢ=1)|i=1, 2, . . . , I} and [symbol] ={(sⱼ, lⱼ=0)|j=1, 2, . . . , J}, where I+J=N. embodiments of the present disclosure may then obtain a new subset [symbol] ₀ from [symbol] by adding the constraint FPR∈[α, β] to [symbol] according to the following steps: 1) The hyper-parameters [α, β] may be replaced with [j_{α}/J, j_{β}/J], where j_{α}=ceiling(J*α)+1 and j_{β}=floor(J*β) are two integers; 2) {sⱼ}∀j: sⱼ∈ [symbol] may be sorted in descending order, where the operator ∀a:b denotes that every instance of a that satisfies the condition b will be included; and 3) [symbol] ₀ is selected as the set of the samples ranked from the top j_{α}^{th} to the j_{β}^{th} positions of the resorted {sⱼ}∀j: sⱼ∈ [symbol] denoted as [symbol] ₀={(sₖ, lₖ=0)|k=1, 2, . . . , K} with K=j_{β}−j_{α}+1.

Thereafter, the pAUC may be calculated as a normalized AUC over [symbol] and [symbol] ₀:

$$pAUC = 1 - \frac{1}{IK} {\sum }_{∀ i : {s}_{i} ∈ P} {\sum }_{∀ k : {s}_{k} ∈ {𝒩}_{0}} [ 𝕀 ( {s}_{i} < {s}_{k} ) + \frac{1}{2} 𝕀 ( {s}_{i} = {s}_{k} ) ] ,$$

where [symbol] (·) is an indicator function that returns 1 if the statement is true, and 0 otherwise. However, directly optimizing this pAUC calculation may be computationally prohibitively expensive (i.e., NP-hard). One common solution for overcoming an NP-hard problem is to relax the indicator function by a hinge loss function:

[symbol]

_{hinge}(z)=max(0,δ−z),

where z=sᵢ-sₖ, and δ>0 is a tunable hyper-parameter. Because the gradient of this hinge-loss function is constant with respect to z, it does not reflect the difference between two samples that cause different errors. Based on the loss function of the least-squares support vector machine (e.g., least-squares versions of related supervised learning methods that analyze data and recognize patterns) the above-noted hinge-loss function [symbol] _{hinge} may be replaced with:

[symbol]

_{hinge}(z)=max(0,δ−z)².

Embodiments of the present disclosure may then replace the [symbol] _{hinge} function with the [symbol] ′_{hinge} in the calculation for pAUC noted above and change the problem of maximizing the pAUC into the equivalent minimization problem, the following pAUC optimization objective (e.g., loss function minimization) may be derived:

$$min \frac{1}{IK} {\sum }_{∀ i : {s}_{i} ∈ P} {\sum }_{∀ k : {s}_{k} ∈ {𝒩}_{0}} {max ( 0 , δ - ( {s}_{i} - {s}_{k} ) )}^{2} .$$

Therefore, the minimization of this formula is based on the similarity scores sᵢ and sₖ.

The processing device may then update parameters associated with the DNN model based on the results of the pAUC optimization objective noted above. For example, the feature extraction DNN may be characterized by weight parameters and embodiments of the present disclosure may adjust the weight parameters to achieve the minimization of pAUC. Furthermore, because the pAUC optimization objective is formulated as a convex optimization problem as defined above, a global optimum solution for each parameter can be achieved.

At 112, the processing device may end the execution of operations for training a feature extraction DNN with a loss function.

For example, a set of newly input utterances from speakers (e.g., new to a speaker verification system feature extraction DNN) may be reviewed to determine if a new training iteration is appropriate based on whether there is enough new input utterance data to warrant a further training iteration (e.g., compared to some specified threshold amount).

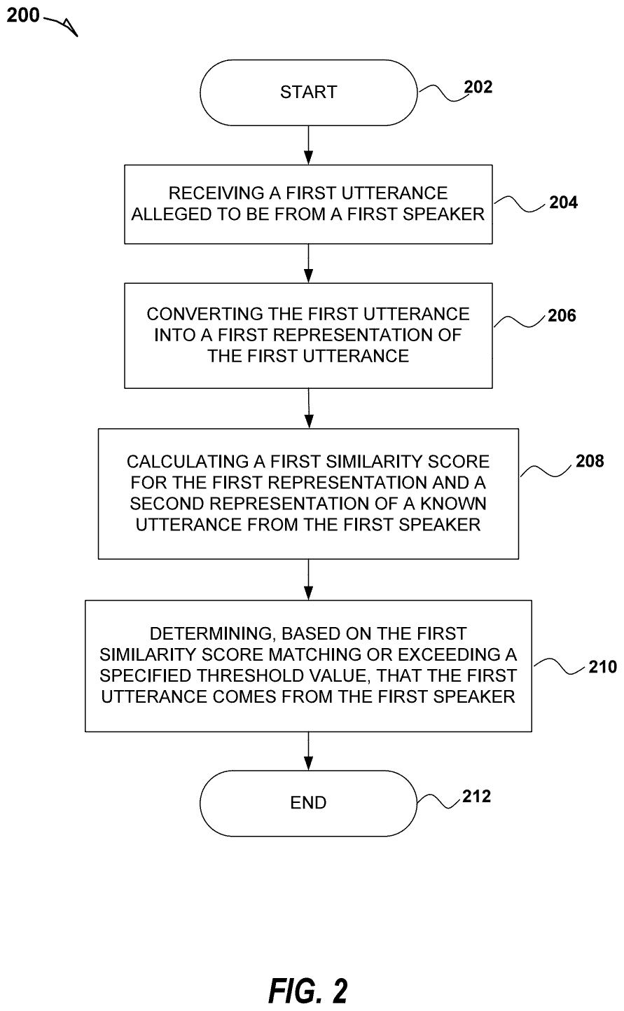

FIG. 2 shows a flow diagram illustrating a method 200 for determining that an utterance comes from a known speaker based on a generated similarity score matching or exceeding a specified threshold value, according to an implementation of the present disclosure.

Referring to FIG. 2, at 202, the processing device may start executing preliminary operations for determining that an utterance comes from a known speaker.

For example, speaker identity vectors (used to verify an utterance alleged to be from the speaker) may be generated and/or updated for each known speaker.

At 204, the DNN may receive a first utterance alleged to be from a first speaker.

For example, the DNN may be communicatively coupled to a microphone used to capture audio signals from the first utterance made by the first speaker claiming to be a known user of a secured computer system in order to gain access to the secured computer system, e.g., a bank's computer system.

At 206, the DNN may convert the received first utterance into a first representation of the first utterance.

For example, the DNN may comprise a multi-layered network to extract speaker features from the captured audio signals and process them to convert them to electronic representations of the extracted features at a lower dimension.

At 208, a first similarity score may be calculated for the first representation and a second representation of a known utterance from the first speaker.

As noted above with respect to 104, of method 100 of FIG. 1, for a given a soft similarity function ƒ(·), embodiments of the present disclosure may obtain a similarity score for representations xₙ and yₙ, denoted as sₙ=ƒ(xₙ, yₙ) where sₙ∈ [symbol] . The similarity function ƒ(·) specified to calculate the similarity scores may be the cosine similarity function:

$${s}_{n} = f ( {x}_{n} , {y}_{n} ) = \frac{{x}_{n}^{T} {y}_{n}}{‖ {x}_{n} ‖ ‖ {y}_{n} ‖} ,$$

where the superscript T is the transpose operator and ∥·∥ is the [symbol] ₂-norm operator.

At 210, determining that the first utterance comes from the first speaker, based on the first similarity score matching or exceeding the specified threshold value (e.g., sₙ≥θ).

As noted above with respect to 104, of method 100 of FIG. 1, for a given a soft similarity function ƒ(·), embodiments of the present disclosure may obtain a similarity score for utterance representations xₙ and yₙ, denoted as sₙ=ƒ(xₙ, yₙ) where sₙ∈ [symbol] . The decision for the similarity of xₙ and yₙ may be based on a threshold value θ as described above with respect to the method of FIG. 1.

A desirable property of verification loss functions is that the training process is consistent with the evaluation procedure used for speaker verification, which make it more proper for speaker verification in comparison with identification loss functions. Accordingly, in some embodiments, an evaluation procedure such as that of \hat{l}ₙ (shown above) may be used for each pair of representations wherein the decision threshold θ may be specified based on the results of the pAUC optimization objective noted above with respect to method 100 of FIG. 1.

At 212, the DNN may end the execution of operations for verifying a speaker identity in order to gain access to a system.

For example, the first speaker may be granted access to the secured computer system based on the results of the determination made at 210 above.

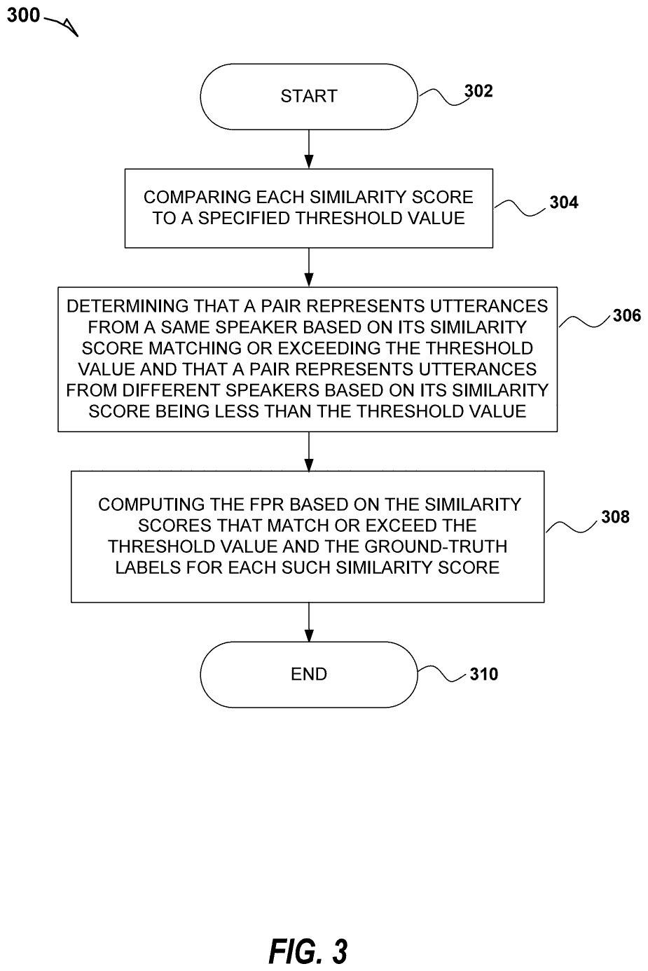

FIG. 3 shows a flow diagram illustrating a method 300 for computing a false positive rate (FPR) for a receiver-operating-characteristic (ROC) curve based on similarity scores that match or exceed a threshold value (e.g., sₙ≥θ) and negative ground-truth labels for each such similarity score, according to an embodiment of the present disclosure.

Referring to FIG. 3, at 302, the processing device may start executing preliminary operations for computing the FPR for the ROC curve based on similarity scores that match or exceed the threshold value and negative ground-truth labels for each such similarity score.

The ROC curve is created by plotting the true positive rate (TPR) against the false positive rate (FPR) at various threshold settings. Therefore, a series of threshold values θ may be specified for the generation of series of values for {TPR(θ), FPR(θ)}, which form an ROC curve as (e.g., as described more fully below with respect to FIG. 5).

At 304, each similarity score (e.g., calculated at 108 of method 100 of FIG. 1) may be compared to a specified threshold value.

As noted above with respect to 104, of method 100 of FIG. 1, for a given a soft similarity function ƒ(·), embodiments of the present disclosure may obtain a similarity score for utterance representations xₙ and yₙ, denoted as sₙ=ƒ(xₙ, yₙ) where sₙ∈ [symbol] . The decision for the similarity of xₙ and yₙ may be based on a threshold value θ as described above with respect to the method of FIG. 1.

At 306, determining that a pair of representations of utterances represents utterances from a same speaker based on its respective similarity score matching or exceeding the threshold value (e.g., sₙ≥θ) and determining that a pair of representations of utterances represents utterances from different speakers based on its respective similarity score being less than the threshold value (e.g., sₙ<θ).

At 308, the FPR may be computed based on the similarity scores that match or exceed the threshold value (e.g., sₙ≥θ so that \hat{l}ₙ=1) and the ground-truth labels for each of these similarity scores (e.g., ground-truth label lₙ=1 or lₙ=0).

With a specified value for θ, a true positive rate (TPR) and a false positive rate (FPR) may be computed from the values of \hat{l}ₙ, ∀n=1, . . . , N. The TPR may be computed as the ratio of the positive trials (i.e., ground-truth label lₙ=1) that are correctly predicted (i.e., \hat{l}ₙ=1) over all trials indicating a positive result. Whereas, the FPR may be computed as the ratio of the negative trials (i.e., ground-truth label lₙ=0) that are wrongly predicted (i.e. \hat{l}ₙ=1) over all trials indicating a negative result (i.e., ground-truth label lₙ=0).

At 310, the DNN may end the execution of operations for computing the FPR for the ROC curve based on the similarity scores and the ground-truth labels.

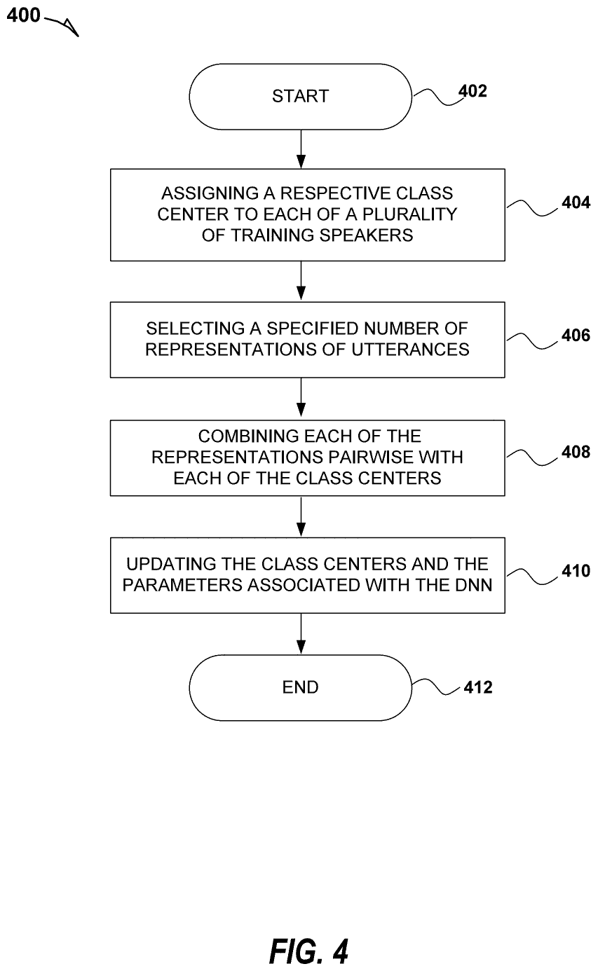

FIG. 4 shows a flow diagram illustrating a method for forming a training data set based on a respective class center assigned to each of a plurality of training speakers (e.g., each speaker selected for training), according to an embodiment of the present disclosure.

Referring to FIG. 4, at 402, the processing device may start executing preliminary operations for forming a training data set based on a respective class center assigned to each training speaker.

For example, the class centers may be randomly initialized so that it may then be updated at each iteration of the training by back propagation.

At 404, assigning a respective class center to each of a plurality of training speakers.

A training data set [symbol] may be formed at each mini-batch iteration of the training of the DNN by using a class-center based learning algorithm. Representations of utterances from each training speaker (e.g., from the set of representations χ) may be used to form the training data set [symbol] . A class center w may be assigned to each of the U speakers so that, for each u^{th} speaker, the class center may be denoted:

{wᵤ},u=1, . . . ,U,

As noted above, during the initial training stage, {wᵤ} may be randomly initialized and subsequently updated at each training iteration by back propagation.

At 406, electing a specified number of representations of utterances.

At each mini-batch iteration of the training of the DNN, a number c of utterances may be randomly selected to form the training data set.

At 408, the DNN may combine each of the representations pairwise with each of the class centers.

At each iteration of the training of the DNN, the c utterances may be combined with {wᵤ}, u=1, . . . , U, pairwise to form [symbol] , which contains c true training trials and (cU−c) imposter training trials.

At 410, updating the class centers and the parameters associated with the DNN.

As noted above, during the initial training stage, {wᵤ} may be randomly initialized and subsequently updated at each training iteration by back propagation.

At 412, the DNN may end the execution of operations for forming a training data set based on a respective class center assigned to each training speaker.

FIG. 5 shows a graph 500 of an ROC curve 502, wherein a section of the ROC curve 502 is delimited between a low FPR value α and a high FPR value β, according to an embodiment of the present disclosure.

With a specified similarity function (e.g., as described above with respect to method 100 of FIG. 1) and a specified value for θ, similarity scores may be generated for a training data set. A true positive rate (TPR) and a false positive rate (FPR) may be computed from the values of \hat{l}ₙ, 1, . . . , N, for the specified similarity function and value for θ. The TPR may then be defined as the ratio of the positive trials (i.e., lₙ=1) that are correctly predicted (i.e., \hat{l}ₙ=1) over all positive trials. Whereas, the FPR may be defined as the ratio of the negative trials (i.e., lₙ=0) that are wrongly predicted (i.e. \hat{l}ₙ=1) over all negative trials.

Varying θ gives a series of values for FPR(θ) and TPR(θ), which respectively form the x-axis and y-axis of the ROC curve 502. The pAUC 504 for the ROC curve 502 may be defined as the area under the ROC curve 502 when the value of the FPR is between [α, β], where α and β are two hyper-parameters. As noted above, the low FPR value α and high FPR value β may be specified based on the requirements of the specific speaker verification application, e.g., different points of interest along the ROC curve 502 for the application.

As noted above, with respect to 110 of method 100 of FIG. 1, the pAUC 504 may be calculated as a normalized AUC over the sets [symbol] and [symbol] ₀:

$$pAUC = 1 - \frac{1}{IK} {\sum }_{∀ i : {s}_{i} ∈ P} {\sum }_{∀ k : {s}_{k} ∈ {𝒩}_{0}} [ 𝕀 ( {s}_{i} < {s}_{k} ) + \frac{1}{2} 𝕀 ( {s}_{i} = {s}_{k} ) ] ,$$

where ∥·( ) is an indicator function that returns 1 if the statement is true, and 0 otherwise. The problem of maximizing the pAUC 504 may be converted into the equivalent minimization problem (e.g., loss function minimization) so that the following pAUC 504 optimization metric may be derived:

$$min \frac{1}{IK} {\sum }_{∀ i : {s}_{i} ∈ P} {\sum }_{∀ k : {s}_{k} ∈ {𝒩}_{0}} {max ( 0 , δ - ( {s}_{i} - {s}_{k} ) )}^{2} .$$

As noted above, the minimization of this formula is carried out over parameters of the DNN based on a similarity function (e.g., the cosine similarity function).

The above-noted pAUC 504 optimization metric can be also related to AUC maximization. The optimization of the AUC of ROC curve 502 is a special case of the pAUC 504 optimization with α=0 and β=1. The performance of a speaker verification system is related to the discriminability of the difficult training trials. However, AUC optimization is trained on [symbol] and [symbol] and these two sets may contain many easy trials, which hinders the focus of the AUC optimization on solving the difficult verification problems. In contrast, the pAUC 504 optimization with a small β is able to select difficult trials at each mini-batch iteration. Furthermore, experimental results discussed below demonstrate that the pAUC 504 optimization is more effective than AUC optimization.

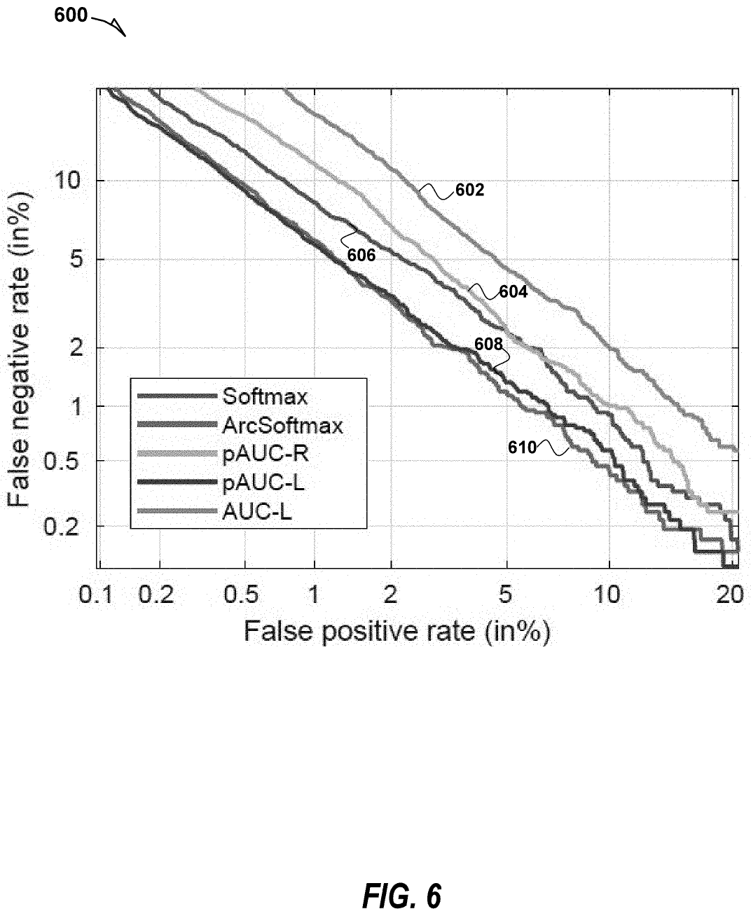

FIG. 6 shows a detection error tradeoff (DET) graph 600 for multiple loss functions (602-610) plotting their respective false negative rates vs. their respective false positive rates for a specified task, according to an embodiment of the disclosure.

Five loss functions were compared, which are the cross-entropy loss with softmax (Softmax—606) and additive angular margin softmax (ArcSoftmax—610), random sampling based pAUC optimization (pAUC-R—604), class-center learning based pAUC optimization (pAUC-L—608), and class-center learning based AUC optimization (AUC-L—602), respectively. Additionally, the published results in the kaldi source code, denoted as Softmax (kaldi), have also been cited below for comparison.

The kaldi method for data preparation was used including the MFCC extraction, voice activity detection, and cepstral mean normalization. For all comparison methods used, the deep embedding models were trained with the same data augmentation strategy and DNN structure (except the output layer) as those used with x-vectors (e.g., described above in Background section). They were implemented by Pytorch with the Adam optimizer. The learning rate was set to 0.001 without learning rate decay and weight decay. The batch-size was set to 128, except for pAUC-R 604 whose batch-size was set to 512. The deep embedding models in the 16 KHZ and 8 KHZ systems were trained with 50 and 300 epochs respectively. The LDA+PLDA back-end was adopted for all comparison methods. The dimension of LDA was set to 256 for the pAUC-L 608, AUC-L 602 and ArcSoftmax 610 of the 16 KHZ system, and was set to 128 for the other evaluations.

For pAUC-R 604, the hyperparameter α was fixed to 0; the hyper-parameter β was set to 0.01 for the 16 KHZ system and 0.1 for the 8 KHZ system; the hyperparameter δ was set to 1.2 for the 16 KHZ system and 0.4 for the 8 KHZ system. For pAUC-L 608, α and δ were set the same as those of pAUC-R 604; β was set to 0.001 for the 16 KHZ system and 0.01 for the 8 KHZ system. For ArcSoftmax 610, implementations adopted the same hyperparameter setting as that used with the x-vectors described above in the Background section.

The evaluation metrics include the equal error rate (EER), minimum detection cost function with P_{target}=10⁻² (DCF10⁻²) and P_{target}=10⁻³ (DCF10⁻³) respectively, and detection error trade-off (DET) curve (e.g., as shown in DET graph 600).

The experimental results on SITW and NIST SRE 2016 are listed in Tables 1 and 2 below respectively. From the results of Softmax 606, it may be seen that the implementation of Softmax 606 via Pytorch achieves similar performance with the kaldi implementation. Moreover, ArcSoftmax 610 significantly outperformed Softmax 606.

The pAUC-L 608 reaches EER scores that are more than 25% and 10% lower than Softmax 606 in the two experimental systems respectively (e.g., 8 KHZ and 16 KHZ). It also achieves comparable performance to the Arc-Softmax 610, which demonstrates that the verification loss functions are comparable to the identification loss functions in performance. The pAUC-L 608 also outperforms pAUC-R 604 significantly, which demonstrates that the class-center learning algorithm (e.g., as described above with respect to method 400 of FIG. 4) is a better training set construction method than the random sampling strategy. It is also seen that AUC-L 602 does not reach the same level of performance as the pAUC-L 608. The DET curves (e.g., 602-610) of the comparison loss function methods are plotted in DET graph 600. From the DET graph 600, it may be observed that that the DET curve of pAUC-L 608 is close to that of ArcSoftmax 610, both of which perform the best among the studied methods.

TABLE 1

| NAME | LOSS | EER(%) | DCF10⁻² | DCF10⁻³ |
|---|---|---|---|---|
| Dev. Core | Softmax (kaldi) | 3.0 | — | — |
| | Softmax | 3.04 | 0.2764 | 0.4349 |
| | ArcSoftmax | 2.16 | 0.2565 | 0.4501 |
| | pAUC-R | 3.20 | 0.3412 | 0.5399 |
| | pAUC-L | 2.23 | 0.2523 | 0.4320 |
| | AUC-L | 4.27 | 0.4474 | 0.6653 |
| Eval. Core | Softmax (kaldi) | 3.5 | — | — |
| | Softmax | 3.45 | 0.3339 | 0.4898 |
| | ArcSoftmax | 2.54 | 0.3025 | 0.5142 |
| | pAUC-R | 3.74 | 0.3880 | 0.5797 |
| | pAUC-L | 2.56 | 0.2949 | 0.5011 |
| | AUC-L | 4.76 | 0.5005 | 0.7155 |

TABLE 2

| NAME | LOSS | EER(%) | DCF10⁻² | DCF10⁻³ |
|---|---|---|---|---|
| Dev. Core | Softmax (kaldi) | 7.52 | — | — |
| | Softmax | 6.76 | 0.5195 | 0.7096 |
| | ArcSoftmax | 5.59 | 0.4640 | 0.6660 |
| | pAUC-R | 15.25 | 0.8397 | 0.9542 |
| | pAUC-L | 6.01 | 0.5026 | 0.7020 |
| | AUC-L | 7.92 | 0.5990 | 0.8072 |
| Eval. Core | Softmax (kaldi) | 4.89 | — | — |
| | Softmax | 4.94 | 0.4029 | 0.5949 |
| | ArcSoftmax | 4.13 | 0.3564 | 0.5401 |
| | pAUC-R | 8.65 | 0.6653 | 0.8715 |
| | pAUC-L | 4.25 | 0.3704 | 0.5471 |
| | AUC-L | 5.36 | 0.4439 | 0.6480 |

This subsection investigates the effects of the hyper-parameters of pAUC-L 608 on performance. The hyperparameters were selected via α=0, β=(0, 1], and δ=[0, 2). The evaluation was accelerated by training a pAUC-L 608 model with 50 epochs using one quarter of the training data at each hyperparameter setting in the 16 KHZ system. The evaluation results are listed below in Table 3. From Table 3, one can see that the parameter β, which controls the range of FPR for the pAUC-L 608 optimization, plays a meaningful role on the performance. The performance is stable if β≤0.1, and drops significantly when β=1, i.e., the AUC-L 608 situation. This is because the pAUC-L 608 method focuses on discriminating the difficult trials automatically instead of considering all training trials as AUC-L 602 did. It may also be observed that the performance with the margin δ≥0.4 is much better than that with δ=0. The pAUC-L 608 method was also evaluated in the 8 KHZ system where the models were trained with 100 epochs using half of the training data. The results are presented below in Table 4, which exhibits similar phenomena as seen in Table 3.

Comparing Tables 3 and 4, it may be observed that the optimal values of β in the two evaluation systems are different. This is mainly due to the different difficulty levels of the two evaluation tasks. Specifically, the classification accuracies on the training data of the 16 KHZ and 8 KHZ systems are 97% and 85% respectively, which indicates that the training trials of the 16 KHZ system are much easier to classify than the training trials of the 8 KHZ system. Because the main job of β is to select the training trials that are most difficult to discriminate, setting β in the 16 KHZ system to a smaller value than that in the 8 KHZ system helps both of the systems reach a balance between the problem of selecting the most difficult trials and gathering enough number of training trials for the DNN training.

TABLE 3

| | δ = 0.0 | δ = 0.4 | δ = 0.8 | δ = 1.2 | δ = 1.6 |
|---|---|---|---|---|---|
| β = 0.0001 | — | NaN | — | | |
| β = 0.001 | 4.69 | 3.04 | 2.71 | 2.58 | 2.81 |
| β = 0.01 | 4.57 | 3.17 | 2.93 | 3.00 | 2.81 |
| β = 0.1 | — | 3.14 | — | — | — |
| β = 1 | — | 4.12 | — | — | — |

TABLE 4

| | δ = 0.0 | δ = 0.4 | δ = 0.8 | δ = 1.2 | δ = 1.6 |
|---|---|---|---|---|---|
| β = 0.001 | 24.07 | 8.29 | 9.70 | 9.58 | 10.85 |
| β = 0.01 | 11.74 | 7.40 | 7.52 | 7.64 | 7.38 |
| β = 0.1 | 12.57 | 8.54 | 9.07 | 9.30 | 9.94 |

The above-noted experimental results demonstrate that the proposed loss function pAUC-L 608 is comparable to other state-of-the-art identification loss functions in speaker verification performance.

FIG. 7 is a block diagram illustrating a machine in the example form of a computer system 700, within which a set or sequence of instructions may be executed to cause the machine to perform any one of the methodologies discussed herein, according to an example embodiment.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors 722, such as a global positioning system (GPS) sensor, accelerometer, gyrometer, magnetometer, or other sensor.

The storage device 716 includes a machine-readable medium 724 on which is stored one or more sets of data structures and instructions 726 (e.g., software) embodying or utilized by any one or more of the methodologies or functions described herein. The instructions 726 may also reside, completely or at least partially, within the main memory 704, static memory 706, and/or within the processor 702 during execution thereof by the computer system 700, with main memory 704, static memory 706, and processor 702 comprising machine-readable media.

While the machine-readable medium 724 is illustrated in an example embodiment to be a single medium, the term “machine-readable medium” may include a single medium or multiple media (e.g., a centralized or distributed database, and/or associated caches and servers) that store the one or more instructions 726. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include volatile or non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 726 may further be transmitted or received over a communications network 728 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog signals or other intangible medium to facilitate communication of such software.

Example computer system 700 may also include an input/output controller 730 to receive input and output requests from the at least one central processor 702, and then send device-specific control signals to the device they control. The input/output controller 730 may free the at least one central processor 702 from having to deal with the details of controlling each separate kind of device.

Language: In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other storage, transmission or display device.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout the disclosure is not intended to mean the same embodiment or implementation unless described as such.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments/implementations will be apparent to those of skill in the art upon reading and understanding the above description. The scope of the disclosure should, therefore, be determined with reference to the appended claims, along with the full scope of equivalents to which such claims are entitled.

1. A method for training a deep neural network (DNN) based on a loss function, the method comprising:
specifying, by a processing device, a similarity function for calculating a similarity score for two representations of utterances;
receiving, by the processing device, a training data set comprising pairs of representations of utterances, wherein each of the pairs of representations of utterances is associated with a corresponding ground-truth label;
calculating, by the processing device, a respective similarity score for each of the pairs of representations of utterances; and
updating, by the processing device, parameters associated with the DNN based on minimizing a loss function associated with an area under a section of a receiver-operating-characteristic (ROC) curve for the similarity scores, wherein the section is delimited between a low false positive rate (FPR) value and a high FPR value.

2. The method of claim 1, further comprising:
receiving a first utterance alleged to be from a first speaker;
converting, using the DNN, the first utterance into a first representation of the first utterance;
calculating, by the processing device, a first similarity score for the first representation and a second representation of a representation of a known utterance from the first speaker; and
determining, by the processing device based on the first similarity score matching or exceeding a specified threshold value, that the first utterance comes from the first speaker.

3. The method of claim 1, wherein the representations of utterances comprise vectors representing features extracted from audio signals using the DNN.

4. The method of claim 1, wherein the specified similarity function is based on a cosine similarity function.

5. The method of claim 1, wherein the low FPR value and the high FPR value are selected based on a determination that the delimited section of the ROC curve includes points used by a speaker verification system.

6. The method of claim 1, further comprising:
comparing, by the processor, each similarity score to a predetermined threshold value;
determining, by the processor, that a pair represents utterances from a same speaker based on a corresponding similarity score matching or exceeding the threshold value and determining that the pair represents utterances from different speakers based on the corresponding similarity score being less than the threshold value; and
computing, by the processor, the FPR based on the similarity scores that match or exceed the threshold value and the ground-truth labels for each such similarity score.

7. The method of claim 1, further comprising forming the training data set by:
assigning a respective class center to each of a plurality of training speakers;
selecting a specified number of representations of utterances;
combining each of the representations pairwise with each of the class centers; and
updating the class centers and the parameters associated with the DNN.

8. A system for verifying a speaker identity, the system comprising:
at least one microphone to capture audio signals; and
a processing device, communicatively coupled to the at least one microphone, to:
specify, by a processing device, a similarity function for calculating a similarity score for two representations of utterances;
receive, by the processing device, a training data set comprising pairs of representations of utterances, wherein each of the pairs of representations of utterances is associated with a corresponding ground-truth label;
calculate, by the processing device, a respective similarity score for each of the pairs of representations of utterances; and
update, by the processing device, parameters associated with the DNN based on minimizing a loss function associated with an area under a section of a receiver-operating-characteristic (ROC) curve for the similarity scores, wherein the section is delimited between a low false positive rate (FPR) value and a high FPR value.

9. The system of claim 8, the processing device further to:
receive, using the microphone, an audio signal comprising a first utterance alleged to be from a first speaker;
convert, using the DNN, the first utterance into a first representation of the first utterance;
calculate a first similarity score for the first representation and a second representation of a representation of a known utterance from the first speaker; and
determine, based on the first similarity score matching or exceeding a specified threshold value, that the first utterance comes from the first speaker.

10. The system of claim 8, wherein the representations of utterances comprise vectors representing features extracted from audio signals using the DNN.

11. The system of claim 8, wherein the specified similarity function is based on a cosine similarity function.

12. The system of claim 8, wherein the low FPR value and the high FPR value are selected based on a determination that the delimited section of the ROC curve includes points used by a speaker verification system.

13. The system of claim 8, the processing device further to:
compare each similarity score to a predetermined threshold value;
determine that a pair represents utterances from a same speaker based on a corresponding similarity score matching or exceeding the threshold value and determining that the pair represents utterances from different speakers based on the corresponding similarity score being less than the threshold value; and
compute the FPR based on the similarity scores that match or exceed the threshold value and the ground-truth labels for each such similarity score.

14. The system of claim 8, the processing device further to form the training data set by:
assigning a respective class center to each of a plurality of training speakers;
selecting a specified number of representations of utterances;
combining each of the representations pairwise with each of the class centers; and
updating the class centers and the parameters associated with the DNN.

15. A non-transitory machine-readable storage medium storing instructions which, when executed, cause a processing device to:
communicate with at least one microphone to capture audio signals;
specify a similarity function for calculating a similarity score for two representations of utterances;
receive a training data set comprising pairs of representations of utterances, wherein each of the pairs of representations of utterances is associated with a corresponding ground-truth label;
calculate a respective similarity score for each of the pairs of representations of utterances; and
update parameters associated with the DNN based on minimizing a loss function associated with an area under a section of a receiver-operating-characteristic (ROC) curve for the similarity scores, wherein the section is delimited between a low false positive rate (FPR) value and a high FPR value.

16. The machine-readable storage medium of claim 15, further comprising instructions which, when executed, cause the processing device to:
receive, using the microphone, an audio signal comprising a first utterance alleged to be from a first speaker;
convert, using the DNN, the first utterance into a first representation of the first utterance;
calculate a first similarity score for the first representation and a second representation of a representation of a known utterance from the first speaker; and
determine, based on the first similarity score exceeding a specified threshold value, that the first utterance comes from the first speaker.

17. The machine-readable storage medium of claim 15, wherein:
the representations of utterances comprise vectors representing features extracted from captured audio signals using the DNN; and
the similarity function is based on one a cosine similarity function.

18. The machine-readable storage medium of claim 15, wherein the low FPR value and the high FPR value are selected based on a determination that the delimited section of the ROC curve includes points used by a system that requires speaker verification.

19. The machine-readable storage medium of claim 15, further comprising instructions which, when executed, cause the processing device to:
compare each similarity score to a predetermined threshold value;
determine that a pair represents utterances from a same speaker based on a corresponding similarity score matching or exceeding the threshold value and determining that the pair represents utterances from different speakers based on the corresponding similarity score being less than the threshold value; and
compute the FPR based on the similarity scores that match or exceed the threshold value and the ground-truth labels for each such similarity score.

20. The machine-readable storage medium of claim 15, further comprising instructions for forming the trading data set which, when executed, cause the processing device to:
assign a respective class center to each of a plurality of training speakers;
select a specified number of representations of utterances;
combine each of the representations pairwise with each of the class centers; and
update the class centers and the parameters associated with the DNN.
